(19) United States
(12) Patent Application Publication
(10) Pub. No.: US 2026/0262126 A1
(43) Pub. Date: Sep. 3, 2026

(54) METHOD AND APPARATUS FOR TRANSMITTING SYSTEM INFORMATION, AND DEVICE, AND STORAGE MEDIUM

(71) Applicant: Beijing Xiaomi Mobile Software Co., Ltd., Beijing (CN)

(72) Inventor: Ting FU, Beijing (CN)

(21) Appl. No.: 18/866,018

(22) PCT Filed: May 17, 2022
(86) PCT No.: PCT/CN2022/093381

§ 371 Date: Nov. 14, 2024

(51) Int. Cl. H04W 76/27

(52) U.S. Cl. CPC H04W 76/27

(57) ABSTRACT

A method for transmitting system information, performed by user equipment, including: in response to the user equipment being configured with a first parameter and requesting, in a radio resource control (RRC) connected state, a network device to transmit a system information block (SIB), receiving the requested SIB transmitted by the network device by the user equipment through dedicated signaling.

### CROSS-REFERENCE TO RELATED APPLICATIONS

The present application is a U.S. National Stage of International Application No. PCT/CN2022/093381, filed on May 17, 2022, the contents of all of which are incorporated herein by reference in their entirety for all purposes.

### BACKGROUND OF THE INVENTION

In new radio (NR), one system information (SI) message includes one or a plurality of system information blocks (SIBs). The plurality of SIBs have the same transmission cycle and broadcast state.

The SI can be divided into cyclically-broadcast SI and non-cyclically-broadcast SI according to the broadcast state. For a terminal in a connected state, if user equipment (UE) needs to obtain a certain SIB, the UE can initiate a message for a request of the SIB through a radio resource control (RRC) layer signaling.

### SUMMARY OF THE INVENTION

The disclosure relates to the technical field of wireless communication, in particular to a method and apparatus for transmitting system information, a device, and a storage medium.

According to a first aspect of examples of the disclosure, a method for transmitting system information is provided and performed by user equipment. The method includes: in response to the user equipment being configured with a first parameter and requesting, in a radio resource control (RRC) connected state, a network device to transmit a system information block (SIB), receiving, by the user equipment through dedicated signaling, the requested SIB transmitted by the network device.

According to a second aspect of the examples of the disclosure, a method for transmitting system information is provided and performed by a network device. The method includes: in response to user equipment in a radio resource control (RRC) connected state requesting the network device to transmit a system information block (SIB) and the user equipment being configured with a first parameter, transmitting the requested SIB to the user equipment by the network device through dedicated signaling.

According to a third aspect of the examples of the disclosure, an apparatus for transmitting system information is provided and applied to user equipment. The apparatus includes a transceiver module, configured to receive through dedicated signaling, in response to the user equipment being configured with a first parameter and requesting, in a radio resource control (RRC) connected state, a network device to transmit a system information block (SIB), the requested SIB transmitted by the network device.

According to a fourth aspect of the examples of the disclosure, an apparatus for transmitting system information is provided and applied to a network device. The apparatus includes a transceiver module, configured to transmit, in response to user equipment in a radio resource control (RRC) connected state requesting the network device to transmit a system information block (SIB) and the user equipment being configured with a first parameter, the requested SIB to the user equipment through dedicated signaling.

According to a fifth aspect of the examples of the disclosure, a communication device is provided. The communication device includes: a processor; and a memory configured to store a processor-executable instruction; where the processor is configured to implement steps of the method for transmitting the system information described by executing the executable instruction in the memory.

According to a sixth aspect of the examples of the disclosure, a communication device is provided. The communication device includes: a processor; and a memory configured to store a processor-executable instruction; where the processor is configured to implement steps of the method for transmitting the system information described by executing the executable instruction in the memory.

According to a seventh aspect of the examples of the disclosure, a non-transitory computer-readable storage medium is provided. An instruction is stored in the non-transitory computer-readable storage medium. A computer is caused to execute steps of the method for transmitting the system information described in a case that the instruction is invoked and executed by the computer.

It should be understood that the foregoing general description and the following detailed description are merely illustrative and explanatory, and cannot limit the disclosure.

### BRIEF DESCRIPTION OF DRAWINGS

Accompanying drawings described are used for providing further understanding of examples of the disclosure and constitute a part of the disclosure. Schematic examples of the disclosure and their descriptions are used to explain the examples of the disclosure, and do not constitute improper limitation to the example of the disclosure. In the figures:

The accompanying drawings here are incorporated into and constitute a part of the specification, illustrating examples conforming to examples of the disclosure, and serving to explain principles of the examples of the disclosure along with the specification.

FIG. 1 is a schematic architecture diagram of a wireless communication system according to an example;

FIG. 2 is a flowchart of a method for transmitting system information according to an example;

FIG. 3 is a flowchart of a method for transmitting system information according to an example;

FIG. 4 is a flowchart of a method for transmitting system information according to an example;

FIG. 5 is a flowchart of a method for transmitting system information according to an example;

FIG. 6 is a flowchart of a method for transmitting system information according to an example;

FIG. 7 is a flowchart of a method for transmitting system information according to an example;

FIG. 8 is a flowchart of a method for transmitting system information according to an example;

FIG. 9 is a flowchart of a method for transmitting system information according to an example;

FIG. 10 is a flowchart of a method for transmitting system information according to an example;

FIG. 11 is a flowchart of a method for transmitting system information according to an example;

FIG. 12 is a block diagram of an apparatus for transmitting system information according to an example;

FIG. 13 is a block diagram of an apparatus for transmitting system information according to an example;

FIG. 14 is a structural diagram of an apparatus for transmitting system information according to an example; and

FIG. 15 is a structural diagram of an apparatus for transmitting system information according to an example.

### DETAILED DESCRIPTION OF THE INVENTION

Examples of the disclosure will be further described with reference to accompanying drawings and in conjunction with specific embodiments.

The example embodiments will be described in detail, and examples thereof are shown in the accompanying drawings. In a case that the following description relates to the accompanying drawings, the same numbers in different accompanying drawings refer to the same or similar elements unless otherwise indicated. The embodiments described in the following examples do not represent all embodiments consistent with the embodiments of the disclosure. Rather, they are merely instances of devices and methods consistent with some aspects of the appended claims of the disclosure.

Terms used in the examples of the disclosure are for the purpose of describing particular embodiments merely and are not intended to limit the embodiments of the disclosure. Singular forms such as “a”, “an” and “the/said” as used in the embodiments of the disclosure are intended to include plural forms as well, unless otherwise clearly indicated in the context. It should also be understood that the term “and/or” as used here refers to and encompasses any or all possible combinations of one or more of associated listed items.

It should be understood that although terms such as first, second and third can be used in the embodiments of the disclosure to describe various information, such information should not be limited to these terms. These terms are merely used to distinguish the same type of information from each other. For example, first information may also be referred to as second information and similarly, second information may also be referred to as first information without departing from the scope of embodiments of the disclosure. Depending on the context, the word “if” as used here may be construed as “at the time of” or “when” or “in response to determining”.

The embodiments of the disclosure are described in detail below, and examples of the embodiments are shown in the accompanying drawings. Throughout the disclosure same or similar reference numerals refer to same or similar elements. The embodiments described below with reference to the accompanying drawings are illustrative, are intended to explain the disclosure, and cannot be understood as limit of the disclosure.

In new radio (NR), one system information (SI) message includes one or a plurality of system information blocks (SIBs). The plurality of SIBs have the same transmission cycle and broadcast state. A base station broadcasts the SI with the SI as the smallest unit. That is, all SIBs included in the SI need to be simultaneously broadcast while broadcasting the SI.

As shown in FIG. 1, a method for determining a resource according to the example of the disclosure may be applied to a wireless communication system 100. The wireless communication system may include, but is not limited to, a network device 101 and user equipment 102. The user equipment 102 is configured to support carrier aggregation. The user equipment 102 may be connected to a plurality of carrier units of the network device 101 including a main carrier unit and one or more auxiliary carrier units.

It should be understood that the wireless communication system 100 may be applied to not only a low-frequency scenario but also a high-frequency scenario. The application scenarios of the wireless communication system 100 include, but are not limited to, a long term evolution (LTE) system, an LTE frequency division duplex (FDD) system, an LTE time division duplex (TDD) system, a worldwide interoperability for micro wave access (WiMAX) communication system, a cloud radio access network (CRAN) system, a future 5th-generation (5G) system, a new radio (NR) communication system, a future evolved public land mobile network (PLMN) system, etc.

The user equipment 102 may be user equipment (UE), a terminal, an access terminal, a terminal unit, a terminal station, a mobile station (MS), a remote station, a remote terminal, a mobile terminal, a wireless communication device, a terminal agent or user equipment, etc. The user equipment 102 may have a wireless transceiving function, and may communicate (for example, in a wireless mode) with one or more network devices 101 of one or more communication systems and receive a network service provided by the network device 101. The network device 101 here includes, but is not limited to, a base station shown in the figure.

The user equipment 102 may be a cellular phone, a cordless phone, a session initiation protocol (SIP) phone, a wireless local loop (WLL) station, a personal digital assistant (PDA) device, a handheld device with a wireless communication function, a computation device or other processing devices connected to a wireless modem, an in-vehicle-mounted device, a wearable device, user equipment in a future 5G network or user equipment in a future evolved PLMN, etc.

The network device 101 may be an access network device (or referred to as an access network site). The access network device refers to a device that provides a network access function, such as a radio access network (RAN) base station. The network device may specifically include a base station (BS) device, or a base station device and a radio resource management device for controlling the base station. The network device may also include a relay station (a relay device), an access point, a base station in the future 5G network, a base station in the future evolved PLMN, or a NR base station. The network device may be a wearable device or an in-vehicle device. The network device may also be a communication chip with a communication module.

For example, the network device 101 includes, but is not limited to, gnodeB (gNB), an evolved node B (eNB) in the LTE system, a radio network controller (RNC), a node B (NB) in a wideband code division multiple access (WCDMA) system, a radio controller in a centralized radio access network (CRAN) system, a base station controller (BSC), a base transceiver station (BTS) in a global system for mobile communications (GSM) or a code division multiple access (CDMA) system, a home base station (for example, a home evolved node B, or a home node B (HNB)), a baseband unit (BBU), a transmitting and receiving point (TRP), a transmitting point (TP), a mobile switch center, etc. in 5G.

The user equipment issues a request for a message of a system information block (SIB) to the network device through radio resource control (RRC) layer signaling. After receiving the request, the network device may transmit the system message by the two methods as follows.
Method 1: if a public search space for receiving other system information is not configured on an activated bandwidth part (BWP) where the user equipment works, the base station may transmit a requested system message to the UE through RRC dedicated signaling. The base station transmits the requested system message by using the dedicated signaling, so the system message only needs to include the requested SIB.
Method 2: if a public search space for receiving other system information is configured on an activated BWP where the user equipment works, the base station may directly broadcast the system information on the activated BWP during a period of time. In this way, the UE may receive the system message. However, in a case that the base station transmits the requested SIB by way of broadcast, the base station needs to broadcast the overall SI that includes the SIB. That is, in a case that the SI includes a plurality of SIBs, all the plurality of SIBs are to be broadcast together.

For method 2, in a case that the base station transmits the requested SIB by way of broadcast, a method for transmitting the requested SI by the base station is required to be the same as a method for cyclically broadcasting the SI in an existing protocol. That is, in each SSB beam direction, the SI needs to be broadcast.

In a case that the UE in a connected state merely requests an SIB, the base station broadcasts the overall SI by way of broadcast, which is higher in energy consumption and resource overhead. Thus, the energy consumption of the base station can be reduced by a method of reducing unnecessary broadcast signals.

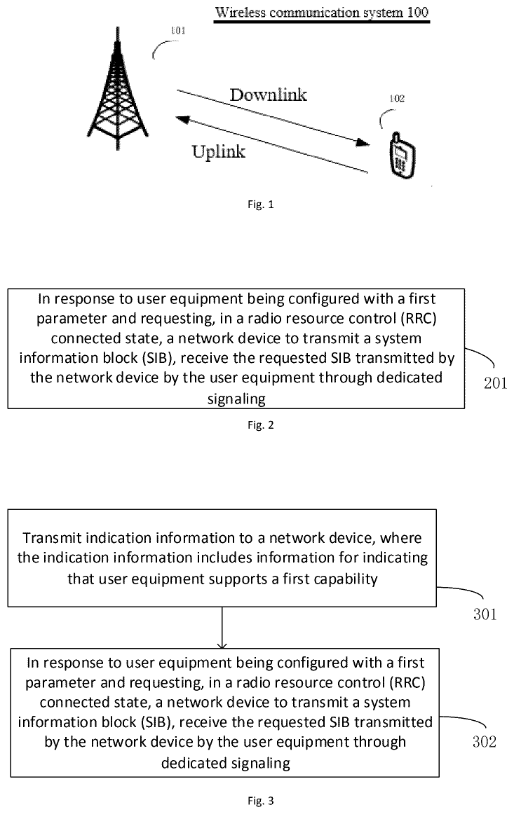

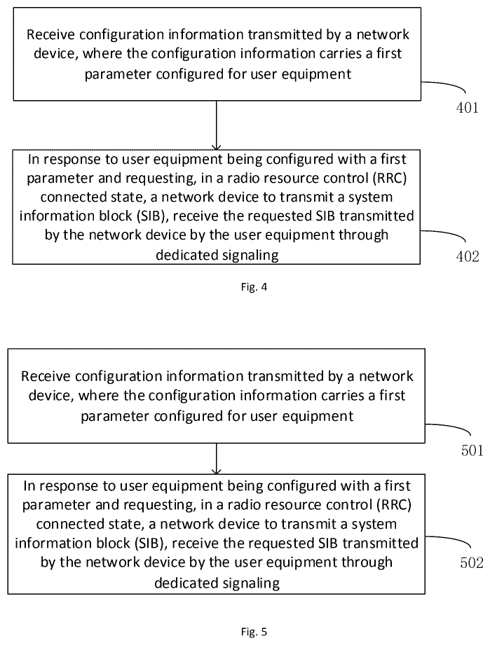

The example of the disclosure provides a method for transmitting system information. The method is applied to user equipment. FIG. 2 is a flowchart of a method for transmitting system information according to an example. As shown in FIG. 2, the method includes step 201.
Step 201 includes receiving, in response to the user equipment being configured with a first parameter and requesting, in a radio resource control (RRC) connected state, a network device to transmit a system information block (SIB), the requested SIB transmitted by the network device by the user equipment through dedicated signaling.

In an embodiment, in a case that the user equipment is configured with the first parameter, if the user equipment requests, in the RRC connected state, one or more SIBs from the network device, the network device transmits the requested SIB to the user equipment through the dedicated signaling under a condition of determining that the user equipment is configured with the first parameter. Thus, the user equipment receives, through the dedicated signaling, the requested SIB transmitted by the network device.

It should be noted that the first parameter is a parameter configured for the user equipment by the network device, and is configured to indicate that the network device transmits the requested SIB to the user equipment through the dedicated signaling.

In the embodiment described, in a case that the user equipment is configured with the first parameter, the requested SIB is transmitted by the network device through the dedicated signaling in a case that the user equipment requests, in the RRC connected state, the SIB from the network device. That is, for the SIB requested by the user equipment in the RRC connected state, the requested SIB is transmitted to the user equipment by the network through the dedicated signaling no matter whether the public search space for receiving the other system information is configured on the activated BWP where the user equipment works. Thus, under the condition of configuring, on the activated BWP where the user equipment works, the public search space for receiving the other system information, an overall SI that includes the requested SIB does not need to be transmitted by the network device, reducing unnecessary broadcast signals, and energy consumption and resource overhead.

The example of the disclosure provides a method for transmitting system information. The method is applied to user equipment. The method may be performed independently or in combination with any other example of the examples of the disclosure. FIG. 3 is a flowchart of a method for transmitting system information according to an example. As shown in FIG. 3, the method includes steps 301 and 302.
Step 301 includes transmitting indication information to the network device. The indication information includes information for indicating that the user equipment supports a first capability.
Step 302 includes receiving, in response to the user equipment being configured with a first parameter and requesting, in a radio resource control (RRC) connected state, the network device to transmit a system information block (SIB), the requested SIB transmitted by the network device by the user equipment through dedicated signaling.

In an embodiment, indication information is transmitted to the network device by the user equipment. The indication information includes information for indicating that the user equipment supports a first capability. In a case that a user equipment is configured with the first parameter, if the user equipment requests, in the RRC connected state, one or more SIBs from the network device, the network device transmits the requested SIB to the user equipment through the dedicated signaling in a case of determining that the user equipment is configured with the first parameter. Thus, the user equipment receives, through the dedicated signaling, the requested SIB transmitted by the network device.

It should be noted that the first capability is a capability of the user equipment to support transmission of the requested SIB to the user equipment by the network device through the dedicated signaling. Illustratively, the first capability indicates that the user equipment supports receiving the requested SIB through the dedicated signaling under the condition of configuring, on an activated bandwidth part (BWP) where the user equipment works, the public search space for receiving the other system information; or the first capability indicates that the user equipment merely supports receiving the requested SIB through the dedicated signaling.

The other system information corresponds to a special name: other system information. The non-cyclically-broadcast SI belongs to the other system information.

In the embodiment described, in a case that the user equipment is configured with the first parameter, the requested SIB is transmitted by the network device through the dedicated signaling in a case that the user equipment requests, in the RRC connected state, the SIB from the network device. That is, for the SIB requested by the user equipment in the RRC connected state, the requested SIB is transmitted to the user equipment by the network through the dedicated signaling no matter whether the public search space for receiving the other system information is configured on the activated BWP where the user equipment works. Thus, under the condition of configuring, on the activated BWP where the user equipment works, the public search space for receiving the other system information, an overall SI that includes the requested SIB does not need to be transmitted by the network device, reducing unnecessary broadcast signals, and energy consumption and resource overhead.

The example of the disclosure provides a method for transmitting system information. The method is applied to user equipment. The method may be performed independently or in combination with any other one of the examples of the disclosure. FIG. 4 is a flowchart of a method for transmitting system information according to an example. As shown in FIG. 4, the method includes steps 401 and 402.
Step 401 includes receiving configuration information transmitted by a network device. The configuration information carries a first parameter configured for the user equipment.
Step 402 includes receiving, in response to the user equipment being configured with the first parameter and requesting, in a radio resource control (RRC) connected state, the network device to transmit a system information block (SIB), the requested SIB transmitted by the network device by the user equipment through dedicated signaling.

The first parameter is configured to indicate that the network device transmits the requested SIB through the dedicated signaling under the condition of configuring, on the BWP where the user equipment works, the public search space for receiving the other system information.

In an embodiment, the network device transmits the configuration information to the user equipment, so as to configure the first parameter for the user equipment. The first parameter is configured to indicate that the network device transmits the requested SIB through the dedicated signaling under the condition of configuring, on the BWP where the user equipment works, the public search space for receiving the other system information. In a case that the user equipment configured with the first parameter requests, in the RRC connected state, one or more SIBs from the network device, the network device transmits the requested SIBs to the user equipment through the dedicated signaling. Thus, the user equipment receives, through the dedicated signaling, the requested SIBs transmitted by the network device.

In an embodiment, indication information is transmitted to the network device by the user equipment. The indication information includes information for indicating that the user equipment supports a first capability. The network device receives this indication information and transmits the configuration information to the user equipment, so as to configure the first parameter for the user equipment. The first parameter is configured to indicate that the network device transmits the requested SIB through the dedicated signaling under the condition of configuring, on the BWP where the user equipment works, the public search space for receiving the other system information. In a case that the user equipment configured with the first parameter requests, in the RRC connected state, one or more SIBs from the network device, the network device transmits the requested SIBs to the user equipment through the dedicated signaling. Thus, the user equipment receives, through the dedicated signaling, the requested SIBs transmitted by the network device.

In an embodiment, indication information is transmitted to the network device by the user equipment. The indication information includes information for indicating that the user equipment supports a first capability. The first capability indicates that the user equipment supports receiving the requested SIB through the dedicated signaling under the condition of configuring, on an activated bandwidth part (BWP) where the user equipment works, a public search space for receiving other system information. The network device receives this indication information and transmits the configuration information to the user equipment, so as to configure the first parameter for the user equipment. The first parameter is configured to indicate that the network device transmits the requested SIB through the dedicated signaling under the condition of configuring, on the BWP where the user equipment works, the public search space for receiving the other system information. In a case that the user equipment configured with the first parameter requests, in the RRC connected state, one or more SIBs from the network device, the network device transmits the requested SIBs to the user equipment through the dedicated signaling. Thus, the user equipment receives, through the dedicated signaling, the requested SIBs transmitted by the network device.

In an embodiment, the configuration information is dedicated configuration information transmitted to the user equipment by the network device. That is, the configuration information is transmitted to the user equipment by the network device through unicast.

In the embodiment described, in a case that the user equipment is configured with the first parameter, the requested SIB is transmitted by the network device through the dedicated signaling in a case that the user equipment requests, in the RRC connected state, the SIB from the network device. That is, for the SIB requested by the user equipment in the RRC connected state, the requested SIB is transmitted to the user equipment by the network through the dedicated signaling no matter whether the public search space for receiving the other system information is configured on the activated BWP where the user equipment works. Thus, under the condition of configuring, on the activated BWP where the user equipment works, the public search space for receiving the other system information, an overall SI that includes the requested SIB does not need to be transmitted by the network device, reducing unnecessary broadcast signals, and energy consumption and resource overhead.

The example of the disclosure provides a method for transmitting system information. The method is applied to user equipment. The method may be performed independently or in combination with any other example of the examples of the disclosure. FIG. 5 is a flowchart of a method for transmitting system information according to an example. As shown in FIG. 5, the method includes steps 501 and 502.
Step 501 includes receiving configuration information transmitted by a network device. The configuration information carries a first parameter configured for the user equipment.
Step 502 includes receiving, in response to the user equipment being configured with the first parameter and requesting, in a radio resource control (RRC) connected state, the network device to transmit a system information block (SIB), the requested SIB transmitted by the network device by the user equipment through dedicated signaling.

The first parameter is configured to indicate that the network device transmits the requested SIB through the dedicated signaling.

In an embodiment, the network device transmits the configuration information to the user equipment, so as to configure the first parameter for the user equipment. The first parameter is configured to indicate that the network device transmits the requested SIB through the dedicated signaling. In a case that the user equipment configured with the first parameter requests, in the RRC connected state, one or more SIBs from the network device, the network device transmits the requested SIBs to the user equipment through the dedicated signaling. Thus, the user equipment receives, through the dedicated signaling, the requested SIBs transmitted by the network device.

In an embodiment, indication information is transmitted to the network device by the user equipment. The indication information includes information for indicating that the user equipment supports a first capability. The network device receives this indication information and transmits the configuration information to the user equipment, so as to configure the first parameter for the user equipment. The first parameter is configured to indicate that the network device transmits the requested SIB through the dedicated signaling. In a case that the user equipment configured with the first parameter requests, in the RRC connected state, one or more SIBs from the network device, the network device transmits the requested SIBs to the user equipment through the dedicated signaling. Thus, the user equipment receives, through the dedicated signaling, the requested SIBs transmitted by the network device.

In an embodiment, the indication information is transmitted to the network device by the user equipment. The indication information includes the information for indicating that the user equipment supports the first capability. The first capability indicates that the user equipment merely supports receiving the requested SIB through the dedicated signaling. The network device receives this indication information and transmits the configuration information to the user equipment, so as to configure the first parameter for the user equipment. The first parameter is configured to indicate that the network device transmits the requested SIB through the dedicated signaling. In a case that the user equipment configured with the first parameter requests, in the RRC connected state, one or more SIBs from the network device, the network device transmits the requested SIBs to the user equipment through the dedicated signaling. Thus, the user equipment receives, through the dedicated signaling, the requested SIBs transmitted by the network device.

In an embodiment, the configuration information is dedicated configuration information transmitted to the user equipment by the network device. That is, the configuration information is transmitted to the user equipment by the network device through unicast.

In the embodiment described, in a case that the user equipment is configured with the first parameter, the requested SIB is transmitted by the network device through the dedicated signaling in a case that the user equipment requests, in the RRC connected state, the SIB from the network device. That is, for the SIB requested by the user equipment in the RRC connected state, the requested SIB is transmitted to the user equipment by the network through the dedicated signaling no matter whether the public search space for receiving the other system information is configured on the activated BWP where the user equipment works. Thus, under the condition of configuring, on the activated BWP where the user equipment works, the public search space for receiving the other system information, an overall SI that includes the requested SIB does not need to be transmitted by the network device, reducing unnecessary broadcast signals, and energy consumption and resource overhead.

The example of the disclosure provides a method for transmitting system information. The method is applied to user equipment. The method may be performed independently or in combination with any other example of the examples of the disclosure. FIG. 6 is a flowchart of a method for transmitting system information according to an example. As shown in FIG. 6, the method includes steps 601, 602, and 603.
Step 601 includes transmitting indication information to a network device. The indication information includes information for indicating that the user equipment supports a first capability.
Step 602 includes receiving configuration information transmitted by the network device. The configuration information carries a first parameter configured for the user equipment.
Step 603 includes receiving, in response to the user equipment being configured with the first parameter and requesting, in a radio resource control (RRC) connected state, the network device to transmit a system information block (SIB), the requested SIB transmitted by the network device by the user equipment through dedicated signaling.

The first parameter is configured to indicate that the network device transmits the requested SIB to set user equipment through the dedicated signaling, and the set user equipment is the user equipment that transmits the indication information.

In an embodiment, the indication information is transmitted to the network device by the user equipment. The indication information includes information for indicating that the user equipment supports the first capability. The network device receives this indication information and transmits the configuration information to the user equipment, so as to configure the first parameter for the user equipment. The first parameter is configured to indicate that the network device transmits, through the dedicated signaling, the requested SIB to the set user equipment, that is, the user equipment that reports the first capability to the network device. In a case that the user equipment configured with the first parameter requests, in the RRC connected state, one or more SIBs from the network device, the network device transmits the requested SIBs to the user equipment through the dedicated signaling. Thus, the user equipment receives, through the dedicated signaling, the requested SIBs transmitted by the network device.

In an embodiment, the indication information is transmitted to the network device by the user equipment. The indication information includes information for indicating that the user equipment supports the first capability. The first capability indicates that the user equipment supports receiving the requested SIB through the dedicated signaling under a condition of configuring, on an activated bandwidth part (BWP) where the user equipment works, a public search space for receiving other system information. The network device receives this indication information and transmits the configuration information to the user equipment, so as to configure the first parameter for the user equipment. The first parameter is configured to indicate that the network device transmits, through the dedicated signaling, the requested SIB to the set user equipment, that is, the user equipment that reports the first capability to the network device. In a case that the user equipment configured with the first parameter requests, in the RRC connected state, the one or more SIBs from the network device, the network device transmits the requested SIBs to the user equipment through the dedicated signaling. Thus, the user equipment receives, through the dedicated signaling, the requested SIBs transmitted by the network device.

In an embodiment, the indication information is transmitted to the network device by the user equipment. The indication information includes information for indicating that the user equipment supports the first capability. The first capability indicates that the user equipment merely supports receiving the requested SIB through the dedicated signaling. The network device receives this indication information and transmits the configuration information to the user equipment, so as to configure the first parameter for the user equipment. The first parameter is configured to indicate that the network device transmits, through the dedicated signaling, the requested SIB to the set user equipment, that is, the user equipment that reports the first capability to the network device. In a case that the user equipment configured with the first parameter requests, in the RRC connected state, the one or more SIBs from the network device, the network device transmits the requested SIBs to the user equipment through the dedicated signaling. Thus, the user equipment receives, through the dedicated signaling, the requested SIBs transmitted by the network device.

In an embodiment, the configuration information is dedicated configuration information transmitted to the user equipment by the network device. That is, the configuration information is transmitted to the user equipment by the network device through unicast.

In an embodiment, the configuration information is configuration information broadcast by the network device. That is, the configuration information is transmitted to the user equipment by the network device through broadcast.

In the embodiment described, in a case that the user equipment is configured with the first parameter, the requested SIB is transmitted by the network device through the dedicated signaling in a case that the user equipment requests, in the RRC connected state, the SIB from the network device. That is, for the SIB requested by the user equipment in the RRC connected state, the requested SIB is transmitted to the user equipment by the network through the dedicated signaling no matter whether the public search space for receiving the other system information is configured on the activated BWP where the user equipment works. Thus, under the condition of configuring, on the activated BWP where the user equipment works, the public search space for receiving the other system information, an overall SI that includes the requested SIB does not need to be transmitted by the network device, reducing unnecessary broadcast signals, and energy consumption and resource overhead.

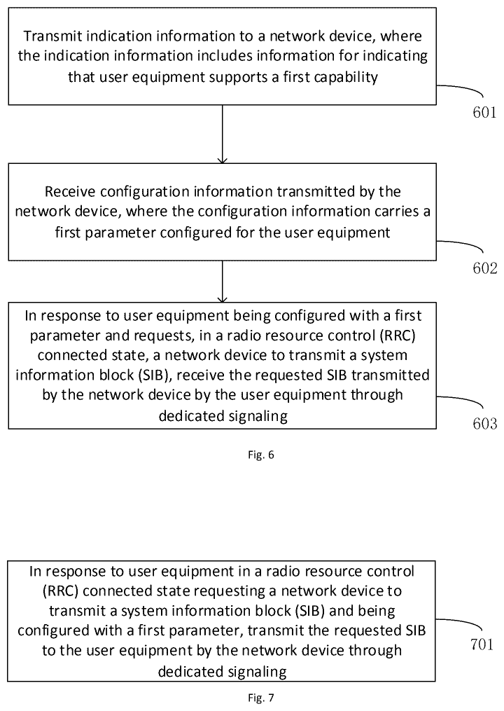

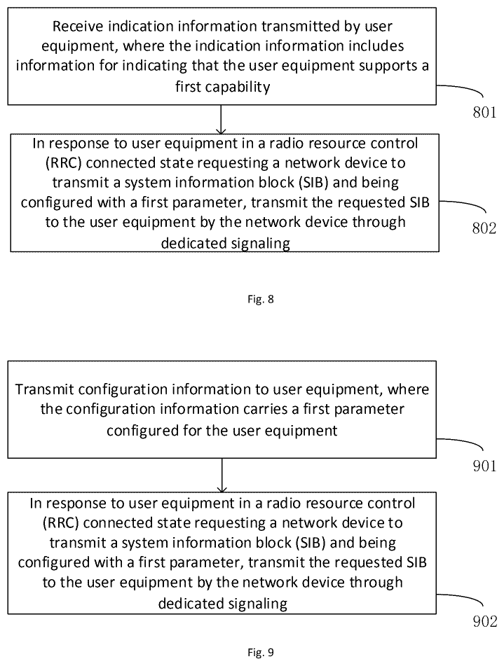

The example of the disclosure provides a method for transmitting system information. The method is applied to a network device. FIG. 7 is a flowchart of a method for transmitting system information according to an example. As shown in FIG. 7, the method includes step 701.
Step 701 includes transmitting, in response to user equipment in a radio resource control (RRC) connected state requesting the network device to transmit a system information block (SIB) and the user equipment being configured with a first parameter, the requested SIB to the user equipment by the network device through dedicated signaling.

In an embodiment, the network device receives a request for one or more SIBs from the user equipment in the RRC connected state, and transmits the requested SIB to the user equipment through the dedicated signaling in a case that the network device determines that the user equipment is configured with the first parameter.

The first parameter is a parameter configured for the user equipment by the network device, and is configured to indicate that the network device transmits the requested SIB to the user equipment through the dedicated signaling.

In the embodiment described, the network device receives a request for the SIB from the user equipment in the RRC connected state, and transmits the requested SIB through the dedicated signaling in a case that the network device determines that the user equipment is configured with the first parameter. That is, for the SIB requested by the user equipment in the RRC connected state, the requested SIB is transmitted to the user equipment by the network through the dedicated signaling no matter whether a public search space for receiving other system information is configured on an activated BWP where the user equipment works. Thus, under the condition of configuring, on the activated BWP where the user equipment works, the public search space for receiving the other system information, an overall SI that includes the requested SIB does not need to be transmitted by the network device, reducing unnecessary broadcast signals, and energy consumption and resource overhead.

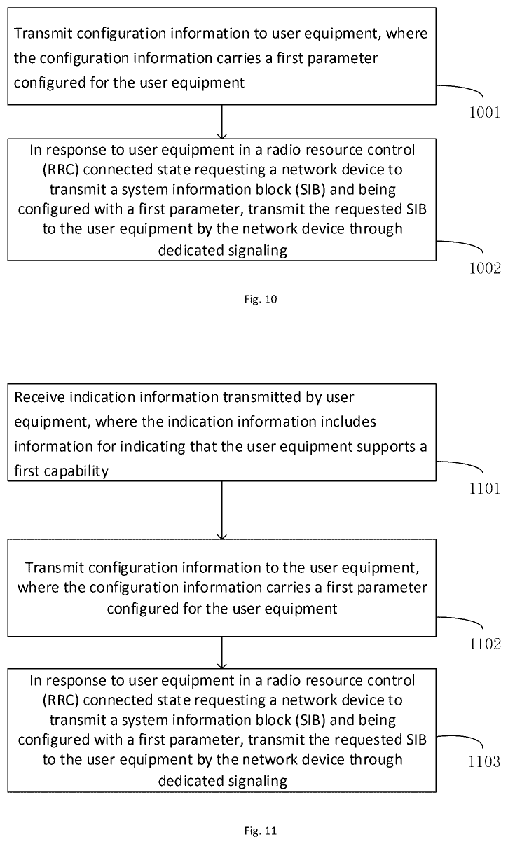

The example of the disclosure provides a method for transmitting system information. The method is applied to a network device. The method may be performed independently or in combination with any other example of the examples of the disclosure. FIG. 8 is a flowchart of a method for transmitting system information according to an example. As shown in FIG. 8, the method includes steps 801 and 802.
Step 801 includes receiving indication information transmitted by user equipment. The indication information includes information for indicating that the user equipment supports a first capability.
Step 802 includes transmitting, in response to the user equipment in a radio resource control (RRC) connected state requesting the network device to transmit a system information block (SIB) and the user equipment being configured with a first parameter, the requested SIB to the user equipment by the network device through dedicated signaling.

In an embodiment, the indication information transmitted by the user equipment is received by the network device. The indication information includes information for indicating that the user equipment supports the first capability. The network device receives a request for one or more SIBs from the user equipment in the RRC connected state, and transmits the requested SIB to the user equipment through the dedicated signaling in a case that the network device determines that the user equipment is configured with the first parameter.

In an embodiment, the indication information transmitted by the user equipment is received by the network device. The indication information includes information for indicating that the user equipment supports the first capability. The network device receives this indication information and transmits configuration information to the user equipment, so as to configure the first parameter for the user equipment. The network device receives a request for one or more SIBs from the user equipment in the RRC connected state and configured with the first parameter, and transmits the requested SIB to the user equipment through the dedicated signaling.

It should be noted that the first capability is a capability of the user equipment to support transmission of the requested SIB to the user equipment by the network device through the dedicated signaling. Illustratively, the first capability indicates that the user equipment supports receiving the requested SIB through the dedicated signaling under a condition of configuring, on an activated bandwidth part (BWP) where the user equipment works, a public search space for receiving other system information; or the first capability indicates that the user equipment merely supports receiving the requested SIB through the dedicated signaling.

In the embodiment described, the network device receives the request for the SIB from the user equipment in the RRC connected state, and transmits the requested SIB through the dedicated signaling in a case that the network device determines that the user equipment is configured with the first parameter. That is, for the SIB requested by the user equipment in the RRC connected state, the requested SIB is transmitted to the user equipment by the network through the dedicated signaling no matter whether the public search space for receiving the other system information is configured on the activated BWP where the user equipment works. Thus, under a condition of configuring, on the activated BWP where the user equipment works, a public search space for receiving other system information, an overall SI that includes the requested SIB does not need to be transmitted by the network device, reducing unnecessary broadcast signals, and energy consumption and resource overhead.

The example of the disclosure provides a method for transmitting system information. The method is applied to a network device. The method may be performed independently or in combination with any other example of the examples of the disclosure. FIG. 9 is a flowchart of a method for transmitting system information according to an example. As shown in FIG. 9, the method includes steps 901 and 902.
Step 901 includes transmitting configuration information to user equipment. The configuration information carries a first parameter configured for the user equipment.
Step 902 includes transmitting, in response to the user equipment in a radio resource control (RRC) connected state requesting the network device to transmit a system information block (SIB) and the user equipment being configured with the first parameter, the requested SIB to the user equipment by the network device through dedicated signaling.

The first parameter is configured to indicate that the network device transmits the requested SIB through the dedicated signaling under the condition of configuring, on a BWP where the user equipment works, a public search space for receiving other system information.

In an embodiment, the network device transmits the configuration information to the user equipment, so as to configure the first parameter for the user equipment. The first parameter is configured to indicate that the network device transmits the information of the requested SIB through the dedicated signaling under a condition of configuring, on the BWP where the user equipment works, a public search space for receiving other system information. The network device receives a request for one or more SIBs from the user equipment in the RRC connected state, and transmits the requested SIB to the user equipment through the dedicated signaling in a case that the network device determines that the user equipment is configured with the first parameter.

In an embodiment, indication information transmitted by the user equipment is received by the network device. The indication information includes information for indicating that the user equipment supports a first capability. The network device receives this indication information and transmits the configuration information to the user equipment, so as to configure the first parameter for the user equipment. The first parameter is configured to indicate that the network device transmits the information of the requested SIB through the dedicated signaling under the condition of configuring, on the BWP where the user equipment works, the public search space for receiving the other system information. The network device receives a request for one or more SIBs from the user equipment in the RRC connected state and configured with the first parameter, and transmits the requested SIB to the user equipment through the dedicated signaling.

In an embodiment, indication information transmitted by the user equipment is received by the network device. The indication information includes information for indicating that the user equipment supports a first capability. The first capability indicates that the user equipment supports receiving the requested SIB through the dedicated signaling under a condition of configuring, on the activated bandwidth part (BWP) where the user equipment works, a public search space for receiving other system information. The network device receives this indication information and transmits the configuration information to the user equipment, so as to configure the first parameter for the user equipment. The first parameter is configured to indicate that the network device transmits the requested SIB through the dedicated signaling under the condition of configuring, on the BWP where the user equipment works, the public search space for receiving the other system information. The network device receives a request for one or more SIBs from the user equipment in the RRC connected state and configured with the first parameter, and transmits the requested SIB to the user equipment through the dedicated signaling.

In an embodiment, the configuration information is dedicated configuration information transmitted to the user equipment by the network device. That is, the configuration information is transmitted to the user equipment by the network device through unicast.

In the embodiment described, the network device receives the request for the SIB from the user equipment in the RRC connected state, and transmits the requested SIB through the dedicated signaling in a case that the network device determines that the user equipment is configured with the first parameter. That is, for the SIB requested by the user equipment in the RRC connected state, the requested SIB is transmitted to the user equipment by the network through the dedicated signaling no matter whether the public search space for receiving the other system information is configured on the activated BWP where the user equipment works. Thus, under a condition of configuring, on the activated BWP where the user equipment works, a public search space for receiving other system information, an overall SI that includes the requested SIB does not need to be transmitted by the network device, reducing unnecessary broadcast signals, and energy consumption and resource overhead.

The example of the disclosure provides a method for transmitting system information. The method is applied to a network device. The method may be performed independently or in combination with any other example of the examples of the disclosure. FIG. 10 is a flowchart of a method for transmitting system information according to an example. As shown in FIG. 10, the method includes steps 1001 and 1002
Step 1001 includes transmitting configuration information to user equipment. The configuration information carries a first parameter configured for the user equipment.
Step 1002 includes transmitting, in response to the user equipment in a radio resource control (RRC) connected state requesting the network device to transmit a system information block (SIB) and the user equipment being configured with the first parameter, the requested SIB to the user equipment by the network device through dedicated signaling.

The first parameter is configured to indicate that the network device transmits the requested SIB through the dedicated signaling.

In an embodiment, the network device transmits the configuration information to the user equipment, so as to configure the first parameter for the user equipment. The first parameter is configured to indicate that the network device transmits the requested SIB through the dedicated signaling. The network device receives a request for one or more SIBs from the user equipment in the RRC connected state, and transmits the requested SIB to the user equipment through the dedicated signaling in a case that the network device determines that the user equipment is configured with the first parameter.

In an embodiment, indication information transmitted by the user equipment is received by the network device. The indication information includes information for indicating that the user equipment supports a first capability. The network device receives this indication information and transmits the configuration information to the user equipment, so as to configure the first parameter for the user equipment. The first parameter is configured to indicate that the network device to transmit the information of the requested SIB through the dedicated signaling. The network device receives a request for one or more SIBs from the user equipment in the RRC connected state and configured with the first parameter, and transmits the requested SIB to the user equipment through the dedicated signaling.

In an embodiment, the indication information transmitted by the user equipment is received by the network device. The indication information includes the information for indicating that the user equipment supports the first capability. The first capability indicates that the user equipment supports the receiving of the requested SIB through the dedicated signaling under the condition of configuring, on the activated bandwidth part (BWP) where the user equipment works, the public search space for receiving the other system information. The network device receives this indication information and transmits the configuration information to the user equipment, so as to configure the first parameter for the user equipment. The first parameter is configured to indicate that the network device transmits the requested SIB through the dedicated signaling. The network device receives the request for the one or more SIBs from the user equipment in the RRC connected state and configured with the first parameter, and transmits the requested SIB to the user equipment through the dedicated signaling.

In an embodiment, the configuration information is dedicated configuration information transmitted to the user equipment by the network device. That is, the configuration information is transmitted to the user equipment by the network device through unicast.

In the embodiment described, the network device receives the request for the SIB from the user equipment in the RRC connected state, and transmits the requested SIB through the dedicated signaling in a case that the network device determines that the user equipment is configured with the first parameter. That is, for the SIB requested by the user equipment in the RRC connected state, the requested SIB is transmitted to the user equipment by the network through the dedicated signaling no matter whether the public search space for receiving the other system information is configured on the activated BWP where the user equipment works. Thus, under the condition of configuring, on the activated BWP where the user equipment works, the public search space for receiving the other system information, an overall SI that includes the requested SIB does not need to be transmitted by the network device, reducing unnecessary broadcast signals, and energy consumption and resource overhead.

The example of the disclosure provides a method for transmitting system information. The method is applied to a network device. The method may be performed independently or in combination with any other example of the examples of the disclosure. FIG. 11 is a flowchart of still another method for transmitting system information according to an example. As shown in FIG. 11, the method includes steps 1101, 1102, and 1103.
Step 1101 includes receiving indication information transmitted by user equipment. The indication information includes information for indicating that the user equipment supports a first capability.
Step 1102 includes transmitting configuration information to the user equipment. The configuration information carries a first parameter configured for the user equipment.
Step 1103 includes transmitting, in response to the user equipment in a radio resource control (RRC) connected state requesting the network device to transmit a system information block (SIB) and the user equipment being configured with the first parameter, the requested SIB to the user equipment by the network device through dedicated signaling.

The first parameter is configured to indicate that the network device transmits the requested SIB to set user equipment through the dedicated signaling, and the set user equipment is the user equipment that transmits the indication information.

In an embodiment, the indication information transmitted by the user equipment is received by the network device. The indication information includes the information for indicating that the user equipment supports the first capability. The network device receives this indication information and transmits the configuration information to the user equipment, so as to configure the first parameter for the user equipment. The first parameter is configured to indicate that the network device transmits, through the dedicated signaling, the requested SIB to the set user equipment, that is, the user equipment that reports the first capability to the network device. The network device receives a request for one or more SIBs from the user equipment in the RRC connected state and configured with the first parameter, and transmits the requested SIB to the user equipment through the dedicated signaling.

In an embodiment, the indication information transmitted by the user equipment is received by the network device. The indication information includes the information for indicating that the user equipment supports the first capability. The first capability indicates that the user equipment supports receiving the requested SIB through the dedicated signaling under a condition of configuring, on an activated bandwidth part (BWP) where the user equipment works, a public search space for receiving other system information. The network device receives this indication information and transmits the configuration information to the user equipment, so as to configure the first parameter for the user equipment. The first parameter is configured to indicate that the network device transmits, through the dedicated signaling, the requested SIB to the set user equipment, that is, the user equipment that reports the first capability to the network device. The network device receives the request for the one or more SIBs from the user equipment in the RRC connected state and configured with the first parameter, and transmits the requested SIB to the user equipment through the dedicated signaling.

In an embodiment, the indication information transmitted by the user equipment is received by the network device. The indication information includes the information for indicating that the user equipment supports the first capability. The first capability indicates that the user equipment merely supports receiving the requested SIB through the dedicated signaling. The network device receives this indication information and transmits the configuration information to the user equipment, so as to configure the first parameter for the user equipment. The first parameter is configured to indicate that the network device transmits, through the dedicated signaling, the requested SIB to the set user equipment, that is, the user equipment that reports the first capability to the network device. The network device receives the request for the one or more SIBs from the user equipment in the RRC connected state and configured with the first parameter, and transmits the requested SIB to the user equipment through the dedicated signaling.

In an embodiment, the configuration information is dedicated configuration information transmitted to the user equipment by the network device. That is, the configuration information is transmitted to the user equipment by the network device through unicast.

In an embodiment, the configuration information is configuration information broadcast by the network device. That is, the configuration information is transmitted to the user equipment by the network device through broadcast.

In the embodiment described, the network device receives the request for the SIB from the user equipment in the RRC connected state, and transmits the requested SIB through the dedicated signaling in a case that the network device determines that the user equipment is configured with the first parameter. That is, for the SIB requested by the user equipment in the RRC connected state, the requested SIB is transmitted to the user equipment by the network through the dedicated signaling no matter whether the public search space for receiving the other system information is configured on the activated BWP where the user equipment works. Thus, under the condition of configuring, on the activated BWP where the user equipment works, the public search space for receiving the other system information, an overall SI that includes the requested SIB does not need to be transmitted by the network device, reducing unnecessary broadcast signals, and energy consumption and resource overhead.

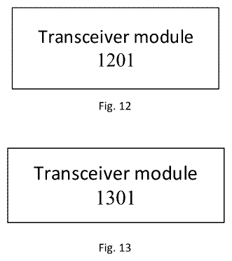

The example of the disclosure provides an apparatus for transmitting system information. The apparatus is applied to user equipment. As shown in FIG. 12, the apparatus includes a transceiver module 1201, configured to receive through dedicated signaling, in response to the user equipment being configured with a first parameter and requesting, in a radio resource control (RRC) connected state, a network device to transmit a system information block (SIB), the requested SIB transmitted by the network device.

In an embodiment, the transceiver module 1201 is further configured to transmit indication information to the network device. The indication information includes information for indicating that the user equipment supports a first capability.

In an embodiment, the first capability indicates that the user equipment supports receiving the requested SIB through the dedicated signaling under a condition of configuring, on an activated bandwidth part (BWP) where the user equipment works, a public search space for receiving other system information.

In an embodiment, the first capability indicates that the user equipment merely supports receiving the requested SIB through the dedicated signaling.

In an embodiment, the transceiver module 1201 is further configured to receive configuration information transmitted by the network device. The configuration information carries the first parameter configured for the user equipment.

The first parameter is configured to indicate that the network device transmits the requested SIB through the dedicated signaling under the condition of configuring, on the BWP where the user equipment works, the public search space for receiving the other system information.

In an embodiment, the transceiver module 1201 is further configured to receive the configuration information transmitted by the network device. The configuration information carries the first parameter configured for the user equipment.

The first parameter is configured to indicate that the network device transmits the requested SIB through the dedicated signaling.

In an embodiment, the configuration information is dedicated configuration information transmitted to the user equipment by the network device.

In an embodiment, the transceiver module 1201 is further configured to receive the configuration information transmitted by the network device. The configuration information carries the first parameter configured for the user equipment.

The first parameter is configured to indicate that the network device transmits the requested SIB to set user equipment through the dedicated signaling, and the set user equipment is the user equipment that transmits the indication information.

In an embodiment, the configuration information is dedicated configuration information transmitted to the user equipment by the network device or configuration information broadcast by the network device.

The example of the disclosure provides an apparatus for transmitting system information. The apparatus is applied to a network device. As shown in FIG. 13, the apparatus includes a transceiver module 1301, configured to transmit, in response to user equipment in a radio resource control (RRC) connected state requesting the network device to transmit a system information block (SIB) and the user equipment being configured with a first parameter, the requested SIB to the user equipment through dedicated signaling.

In an embodiment, the transceiver module 1301 is further configured to receive indication information transmitted by the user equipment. The indication information includes information for indicating that the user equipment supports a first capability.

In an embodiment, the first capability indicates that the user equipment supports receiving the requested SIB through the dedicated signaling under a condition of configuring, on an activated bandwidth part (BWP) where the user equipment works, a public search space for receiving other system information.

In an embodiment, the first capability indicates that the user equipment merely supports receiving the requested SIB through the dedicated signaling.

In an embodiment, the transceiver module 1301 is further configured to transmit configuration information to the user equipment. The configuration information carries the first parameter configured for the user equipment;

The first parameter is configured to indicate that the network device transmits the requested SIB through the dedicated signaling under the condition of configuring, on the BWP where the user equipment works, the public search space for receiving the other system information.

In an embodiment, the transceiver module 1301 is further configured to transmit configuration information to the user equipment. The configuration information carries the first parameter configured for the user equipment;

The first parameter is configured to indicate that the network device transmits the requested SIB through the dedicated signaling.

In an embodiment, the configuration information is dedicated configuration information transmitted to the user equipment by the network device.

In an embodiment, the transceiver module 1301 is further configured to transmit configuration information to the user equipment. The configuration information carries the first parameter configured for the user equipment.

The first parameter is configured to indicate that the network device transmits the requested SIB to set user equipment through the dedicated signaling, and the set user equipment is the user equipment that transmits the indication information.

In an embodiment, the configuration information is dedicated configuration information transmitted to the user equipment by the network device or configuration information broadcast by the network device.

The example of the disclosure provides a communication device. The communication device includes: a processor; and a memory, configured to store a processor-executable instruction; the processor is configured to implement steps of the method for transmitting the system information described by executing the executable instruction in the memory.

The example of the disclosure provides a communication device. The communication device includes: a processor; and a memory, configured to store a processor-executable instruction; the processor is configured to implement steps of the method for transmitting system information described by executing the executable instruction in the memory.

The example of the disclosure provides a non-transitory computer-readable storage medium. The non-transitory computer-readable storage medium stores an instruction. A computer is caused to execute steps of the method for transmitting system information described in a case that the instruction is invoked and executed by the computer.

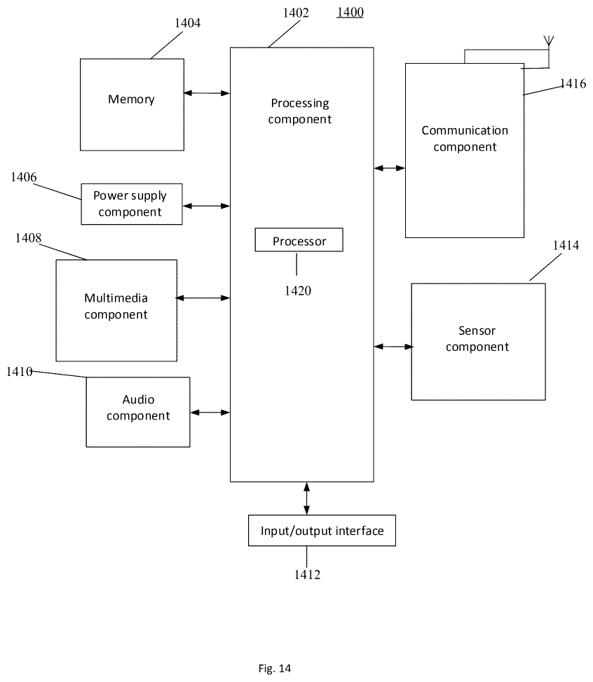

FIG. 14 is a block diagram of a device 1400 for transmitting system information according to an example. For example, the device 1400 may be a mobile phone, a computer, a digital broadcast terminal, a message transceiver device, a game console, a tablet device, a medical device, a fitness device, a personal digital assistant, etc.

With reference to FIG. 14, the device 1400 may include one or more of components as follows: a processing component 1402, a memory 1404, a power supply component 1406, a multimedia component 1408, an audio component 1410, an input/output (I/O) interface 1412, a sensor component 1414, and a communication component 1416.

The processing component 1402 generally controls an overall operation of the device 1400, such as an operation associated with display, a telephone call, data communication, a camera operation, and a record operation. The processing component 1402 may include one or more processors 1420 for executing an instruction, to complete all or part of steps of the method described. In addition, the processing component 1402 may include one or more modules facilitating interaction between the processing component 1402 and other components. For example, the processing component 1402 may include a multimedia module to facilitate interaction between the multimedia component 1408 and the processing component 1402.

The memory 1404 is configured to store various types of data to support the operation on the device 1400. Instances of these data include instructions for any application or method operated on the device 1400, contact data, phonebook data, messages, pictures, videos, etc. The memory 1404 may be implemented by any type of volatile or non-volatile storage devices or their combinations, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk and an optical disk.

The power supply component 1406 energizes various components of the device 1400. The power supply component 1406 may include a power management system, one or more power supplies, and other components associated with power generation, management and distribution for the device 1400.

The multimedia component 1408 includes a screen providing an output interface between the device 1400 and a user. In some examples, the screen may include a liquid crystal display (LCD) and a touch panel (TP). If the screen includes the touch panel, the screen may be implemented as a touch screen to receive an input signal from the user. The touch panel includes one or more touch sensors to sense touch, swipe, and gestures on the touch panel. The touch sensor may not only sense a boundary of a touch or swipe action, but also measure time of duration and a pressure associated with the touch or swipe operation. In some examples, the multimedia component 1408 includes a front-facing camera and/or a rear-facing camera. In a case that the device 1400 is in an operational mode, for example, a photographing mode or a video mode, the front-facing camera and/or the rear-facing camera may receive external multimedia data. Each of the front-facing camera and the rear-facing camera may be a fixed-focus optical lens system or have a focal length and an optical zoom capacity.

The audio component 1410 is configured to output and/or input an audio signal. For example, the audio component 1410 includes a microphone (MIC). In a case that the device 1400 is in an operational mode, such as a call mode, a recording mode or a voice recognition mode, the microphone is configured to receive an external audio signal. The audio signal received may be further stored in the memory 1404 or transmitted via the communication component 1416. In some examples, the audio component 1410 further includes a speaker configured to output the audio signal.

The I/O interface 1412 provides an interface between the processing component 1402 and a peripheral interface module. The peripheral interface module may be a keyboard, a click wheel, a button, etc. These buttons may include, but are not limited to: a home button, a volume button, a start button and a lock button.

The sensor component 1414 includes one or more sensors configured to provide state assessment in various aspects for the device 1400. For example, the sensor component 1414 may detect an on/off state of the device 1400, and relative location of the components. For example, the components are a display and a keypad of the device 1400. The sensor component 1414 may also detect a location change of the device 1400 or a component of the device 1400, presence or absence of contact between the user and the device 1400, orientation or acceleration/deceleration of the device 1400, and a temperature change of the device 1400. The sensor component 1414 may include a proximity sensor configured to detect the presence of a nearby object without any physical touch. The sensor component 1414 may further include an optical sensor, such as a complementary metal-oxide-semiconductor transistor (CMOS) or charge-coupled device (CCD) image sensor for use in an imaging application. In some examples, the sensor component 1414 may further include an acceleration sensor, a gyroscope sensor, a magnetic sensor, a pressure sensor or a temperature sensor.

The communication component 1416 is configured to facilitate wired or wireless communication between the device 1400 and other devices. The device 1400 may access a wireless network based on a communication standard, such as WiFi, the 2nd generation mobile communication technology (2G) or the 3rd generation mobile communication technology (3G), or their combinations. In an illustrative example, the communication component 1416 receives a broadcast signal or broadcast related information from an external broadcast management system via a broadcast channel. In an illustrative example, the communication component 1416 further includes a near field communication (NFC) module to promote short-range communication. For example, the NFC module may be implemented based on a radio-frequency identification (RFID) technology, an infrared data association (IrDA) technology, an ultra-wide band (UWB) technology, a Bluetooth (BT) technology, etc.

In an illustrative example, the device 1400 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors or other electronic elements for executing the method.

In an illustrative example, a non-transitory computer-readable storage medium including an instruction is further provided, such as the memory 1404 including an instruction. The described instruction may be executed by the processor 1420 of the device 1400 to complete the method. For example, the non-transitory computer-readable storage medium may be a read-only memory (ROM), a random-access memory (RAM), a compact disc read-only memory (CD-ROM), a magnetic tape, a floppy disc, an optical data storage device, etc.

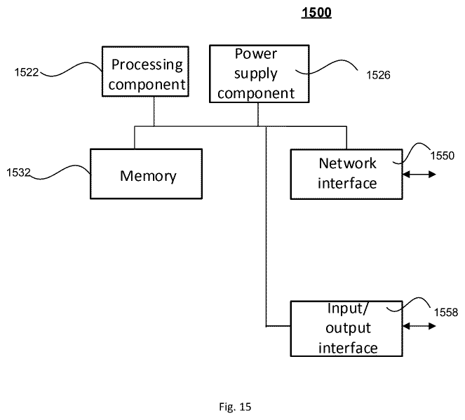

FIG. 15 is a block diagram of a device 1500 for transmitting system information according to an example. For example, the device 1500 may be provided as a base station. With reference to FIG. 15, the device 1500 includes a processing component 1522 and further includes one or more processors, and memory resources represented by a memory 1532 for storing instructions, such as applications that may executed by the processing component 1522. The applications stored in the memory 1532 may include one or more modules each corresponding to a set of instructions. Further, the processing component 1522 is configured to execute the instruction, so as to execute a method for accessing an unlicensed channel.

The device 1500 may further include a power supply component 1526 configured to execute power management of the device 1500, a wired or wireless network interface 1550 configured to network the device 1500, and an input/output (I/O) interface 1559. The device 1500 may operate an operating system stored in the memory 1532, such as Windows Server™, Mac OS X™, Unix™, Linux™ and FreeBSD™.

The technical solution according to the example of the disclosure can have the beneficial effects as follows.

In a case that the user equipment is configured with the first parameter, the requested SIB is transmitted by the network device through the dedicated signaling in a case that the user equipment requests, in the RRC connected state, the SIB from the network device. That is, for the SIB requested by the user equipment in the RRC connected state, the requested SIB is transmitted to the user equipment by the network device through the dedicated signaling no matter whether the public search space for receiving the other system information is configured on the activated BWP where the user equipment works. Thus, under a condition of configuring, on the activated BWP where the user equipment works, the public search space for receiving the other system information, an overall SI that includes the requested SIB does not need to be transmitted by the network device, reducing unnecessary broadcast signals and reducing energy consumption and resource overhead.

A person of ordinary skill in the art will readily conceive of other examples of the example of the disclosure after taking into account the description and implementing an invention disclosed here. The disclosure is intended to encompass any variation, use or adaptive change of the example of the disclosure, which follows general principles of the example of the disclosure and includes public general knowledge or conventional technical means in the technical field not disclosed in the disclosure. The specification and the examples are merely considered illustrative, and a true scope and spirit of the disclosure are indicated by the following claims.

It should be understood that the example of the disclosure is not limited to precise structures described and shown in the accompanying drawings, and various modifications and changes can be made without departing from the scope of the disclosure. The scope of the example of the disclosure is merely limited by the appended claims.

### INDUSTRIAL APPLICABILITY

In a case that user equipment is configured with a first parameter, a requested SIB is transmitted by a network device through dedicated signaling if the user equipment requests, in an RRC connected state, the SIB from the network device. That is, for the SIB requested by the user equipment in the RRC connected state, the requested SIB is transmitted to the user equipment by the network through the dedicated signaling no matter whether a public search space for receiving other system information is configured on an activated BWP where the user equipment works. Thus, under the condition of configuring, on the activated BWP where the user equipment works, the public search space for receiving the other system information, an overall SI that includes the requested SIB does not need to be transmitted by the network device, reducing unnecessary broadcast signals, and energy consumption and resource overhead.

1. A method for transmitting system information, performed by user equipment, comprising:
in response to the user equipment being configured with a first parameter and requesting, in a radio resource control (RRC) connected state, a network device to transmit a system information block (SIB), receiving, by the user equipment through dedicated signaling, the requested SIB transmitted by the network device.

2. The method according to claim 1, further comprising:
transmitting indication information to the network device, wherein the indication information comprises information for indicating that the user equipment supports a first capability.

3. The method according to claim 2, wherein
the first capability indicates that the user equipment supports receiving the requested SIB through the dedicated signaling under a condition of configuring, on an activated bandwidth part (BWP) where the user equipment works, a public search space for receiving other system information, or
the first capability indicates that the user equipment merely supports receiving the requested SIB through the dedicated signaling.

4. (canceled)

5. The method according to claim 1, further comprising:
receiving configuration information transmitted by the network device, wherein the configuration information carries the first parameter configured for the user equipment;
wherein the first parameter is configured to indicate that the network device transmits the requested SIB through the dedicated signaling under a condition of configuring, on a bandwidth part (BWP) where the user equipment works, a public search space for receiving other system information.

6. The method according to claim 1, further comprising:
receiving configuration information transmitted by the network device, wherein the configuration information carries the first parameter configured for the user equipment;
wherein the first parameter is configured to indicate that the network device transmits the requested SIB through the dedicated signaling.

7. The method according to claim 5, wherein
the configuration information is dedicated configuration information transmitted to the user equipment by the network device.

8. The method according to claim 2, further comprising:
receiving configuration information transmitted by the network device, wherein the configuration information carries the first parameter configured for the user equipment;
wherein the first parameter is configured to indicate that the network device transmits the requested SIB to set user equipment through the dedicated signaling, and the set user equipment is the user equipment that transmits the indication information.

9. The method according to claim 8, wherein
the configuration information is dedicated configuration information transmitted to the user equipment by the network device or configuration information broadcast by the network device.

10. A method for transmitting system information, performed by a network device, comprising:
in response to user equipment in a radio resource control (RRC) connected state requesting the network device to transmit a system information block (SIB) and the user equipment being configured with a first parameter, transmitting the requested SIB to the user equipment by the network device through dedicated signaling.

11. The method according to claim 10, further comprising:
receiving indication information transmitted by the user equipment, wherein the indication information comprises information for indicating that the user equipment supports a first capability.

12. The method according to claim 11, wherein
the first capability indicates that the user equipment supports receiving the requested SIB through the dedicated signaling under a condition of configuring, on an activated bandwidth part (BWP) where the user equipment works, a public search space for receiving other system information, or
the first capability indicates that the user equipment merely supports receiving the requested SIB through the dedicated signaling.

13. (canceled)

14. The method according to claim 10, further comprising:
transmitting configuration information to the user equipment, wherein the configuration information carries the first parameter configured for the user equipment;
wherein the first parameter is configured to indicate that the network device transmits the requested SIB through the dedicated signaling under a condition of configuring, on a bandwidth part (BWP) where the user equipment works, a public search space for receiving other system information.

15. The method according to claim 10, further comprising:
transmitting configuration information to the user equipment, wherein the configuration information carries the first parameter configured for the user equipment;
wherein the first parameter is configured to indicate that the network device transmits the requested SIB through the dedicated signaling.

16. The method according to claim wherein
the configuration information is dedicated configuration information transmitted to the user equipment by the network device.

17. The method according to claim 11, further comprising:
transmitting configuration information to the user equipment, wherein the configuration information carries the first parameter configured for the user equipment;
wherein the first parameter is configured to indicate that the network device transmits the requested SIB to set user equipment through the dedicated signaling, and the set user equipment is the user equipment that transmits the indication information.

18. The method according to claim 17, wherein
the configuration information is dedicated configuration information transmitted to the user equipment by the network device or configuration information broadcast by the network device.

19-20. (canceled)

21. A communication device, comprising:
a processor; and
a memory configured to store a processor-executable instruction;
wherein the processor, when executing the processor-executable instruction in the memory, is configured to:
in response to user equipment being configured with a first parameter and requesting, in a radio resource control (RRC) connected state, a network device to transmit a system information block (SIB), receive, through dedicated signaling, the requested SIB transmitted by the network device.

22. A communication device, comprising:
a processor; and
a memory configured to store a processor-executable instruction;
wherein the processor is configured to implement steps of the method for transmitting the system information according to claim 10 by executing the processor-executable instruction in the memory.

23. A non-transitory computer-readable storage medium, storing an instruction, wherein the instruction, when being invoked and executed by a computer, causes the computer to execute steps of the method for transmitting the system information according to claim 1.

24. A non-transitory computer-readable storage medium, storing an instruction, wherein the instruction, when being invoked and executed by a computer, causes the computer to execute steps of the method for transmitting the system information according to claim 10.
